(19) United States
(12) Patent Application Publication
(10) Pub. No.: US 2007/0106773 A1
(43) Pub. Date: May 10, 2007

(54) Method and apparatus for processing of heterogeneous units of work

(75) Inventors: Jeffrey A. Gallino, Cape Coral, FL (US); Michael Dwyer, Fort Myers, FL (US); Sean Hart, Cape Coral, FL (US); David Goedecke, Fort Myers, FL (US); Peter Slade, Valrico, FL (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: CallMiner, Inc., Fort Myers, FL (US)

(21) Appl. No.: 11/330,594

(22) Filed: Jan. 12, 2006

Related U.S. Application Data
(60) Provisional application No. 60/729,088, filed on Oct. 21, 2005.

(51) Int. Cl. G06F 15/173

(52) U.S. Cl. 709/223

(57) ABSTRACT

Methods and apparatus are provided which may be employed to perform speech recognition processing on a grid computing system. In some embodiments, the grid computing system includes a server system which receives processing tasks from one or more client applications, divides the processing tasks into units of work, and assigns the units of work to one or more of the nodes. Dividing a processing task into units of work may involve dividing audio input data into segments defined by natural speech boundaries. A mathematical representation may be created for each segment prior to its distribution on the grid to minimize network traffic. A node in the system may perform heterogeneous units of work concurrently, such as by isolating the execution of each unit of work in an application domain.

### CROSS-REFERENCE TO RELATED APPLICATIONS

This application claims priority under 35 U.S.C. § 119(e) to U.S. Provisional Application Ser. No. 60/729,088, entitled “Method and Apparatus for Processing Heterogeneous Units of Work,” filed on Oct. 21, 2005, which is incorporated by reference in its entirety.

### FIELD OF INVENTION

This invention relates to computer systems, and more particularly to computer systems in which the processing for a particular task may be performed by more than one processor. More specifically, the invention relates to methods and apparatus for performing speech recognition processing on a grid computing system.

### BACKGROUND OF INVENTION

Performing computationally intensive tasks in a cost-effective manner is a long-standing goal in the realm of computer engineering and in various disciplines that rely on large-scale computing. In one approach, called grid computing, systems employ the unused resources of a plurality of computers (“nodes,” which generally are personal computers, but may be any type of device having processing capacity) to perform large-scale processing tasks (e.g., computation tasks) while avoiding a need to purchase all of those computers. For example, in many grid computing systems, unused CPU cycles and/or storage on each node may be exploited to perform a small portion of a larger task while the node would otherwise be idle or lightly used. Nodes may be localized or geographically dispersed, and may be commonly owned or have diverse owners. Generally, an application service implemented on each node communicates via a communications network (e.g., the Internet) with one or more central server systems, which assign portions of an overall processing task(s) to one or more nodes. A node typically reports its progress and provides results to the server(s) via the network, and the server(s) compile the results. Nodes on a grid computing system are typically heterogeneous resources which may have different platforms, hardware/software architectures, and computer languages.

The SETI@home project, which processes data gathered by radio telescopes to help in the search for extraterrestrial intelligence, is one of the most widely known grid computing efforts. Other projects have been initiated to help with processing tasks such as protein folding, cancer research, mathematical problems and climate models. Grid computing efforts have yielded results in efforts that may have otherwise required prohibitive investment or delay.

One advantage of grid computing systems is that processing tasks which are too large for any single supercomputer may be performed, and yet the flexibility to perform multiple smaller processing tasks is also retained. In addition, grid computing systems may allow available computing power to be more efficiently exploited, and allow the intermittent processing demands of large tasks to be more efficiently addressed than by purchasing hardware that is used only to satisfy peak needs. They may also allow a user to avoid capital expenditure and to pay only on an “as used” basis for computing resources.

### SUMMARY OF INVENTION

Applicants have appreciated that conventional grid computing systems are limited with respect to performing certain types of work, such as speech recognition processing. Accordingly, although the invention is not limited to being used to perform speech recognition processing, embodiments thereof improve the ability of conventional grid computing systems to support certain types of work, such as speech recognition processing. In accordance with some embodiments of the invention, a method is provided for use in a grid computing system comprising a server system in networked communication with a plurality of nodes, the server system being operable to divide a processing task into units of work and to assign each of the units of work to one of the plurality of nodes. The method, performed by a node, comprises acts of: (A) receiving a first unit of work from the server system, the first unit of work requiring an execution of a first sequence of instructions; (B) determining whether the first sequence of instructions is stored on the node; (C) if it is determined that the first sequence of instructions is not stored on the node, retrieving the first sequence of instructions from the server system; (D) executing the first sequence of instructions to perform the unit of work.

In accordance with other embodiments of the invention, a node is provided for use in a grid computing system comprising a server system in networked communication with a plurality of nodes, the server system being operable to divide a processing task into units of work and to assign each of the units of work to one of the plurality of nodes. The node is operable to: (A) receive a first unit of work from the server system, the first unit of work requiring an execution of a first sequence of instructions; (B) determine whether the first sequence of instructions is stored on the node; (C) if it is determined that the first sequence of instructions is not stored on the node, retrieve the first sequence of instructions from the server system; and (D) execute the first sequence of instructions to perform the unit of work.

In accordance with yet other embodiments of the invention, a computer-readable medium article is provided having stored thereon signals comprising instructions which, when executed by a server system in a grid computing system, wherein the server system is in networked communication with a plurality of nodes, cause the server system to be operable to divide a processing task into units of work and to assign each of the units of work to one of the plurality of nodes, according to a method, performed by a node, comprising acts of: (A) receiving a first unit of work from the server system, the first unit of work requiring an execution of a first sequence of instructions; (B) determining whether the first sequence of instructions is stored on the node; (C) if it is determined that the first sequence of instructions is not stored on the node, retrieving the first sequence of instructions from the server system; and (D) executing the first sequence of instructions to perform the unit of work.

### BRIEF DESCRIPTION OF DRAWINGS

In the drawings, in which each identical or nearly identical component that is illustrated in various figures is represented by a like numeral:

FIG. 1 depicts an exemplary system configuration in which aspects of embodiments of the invention may be implemented;

FIG. 2 is a block diagram depicting a schema for an exemplary database in which information relating to processing tasks may be stored, in accordance with some embodiments of the invention;

FIG. 3 is a flow diagram depicting a process by means of which a server may notify one or more nodes of the availability of work, in accordance with some embodiments of the invention;

FIGS. 4A and 4B depict exemplary arrangements of information created in support of the process described with reference to FIG. 3, in accordance with some embodiments of the invention;

FIG. 5 is a block diagram depicting exemplary components which may be implemented on a server system, in accordance with some embodiments of the invention;

FIG. 6A is a depiction of a user interface screen by means of which processing tasks on a grid computing system may be monitored, according to some embodiments of the invention;

FIG. 6B is a depiction of a user interface screen by means of which units of work on a grid computing system may be monitored, according to some embodiments of the invention;

FIG. 7 is a block diagram depicting an exemplary technique for concurrently processing heterogeneous units of work on a node, in accordance with some embodiments of the invention;

FIG. 8 is a block diagram depicting another example of a technique for concurrently processing heterogeneous units of work on a node, in accordance with some embodiments of the invention; and

FIG. 9 is a flow diagram depicting one example of a process performed by a node to dynamically acquire a handler used to perform a unit of work, in accordance with some embodiments of the invention.

### DETAILED DESCRIPTION

Applicants have appreciated that while conventional grid computing systems can be useful in completing large-scale processing tasks, they have limitations in terms of the types of work that the system is capable of performing. These limitations can curb the effectiveness of conventional grid computing systems in certain contexts, such as speech recognition processing. Accordingly, although the invention is not limited to being used to perform speech recognition processing, various embodiments of the invention provide features that improve the ability of grid computing systems to support speech recognition processing.

One key limitation of conventional grid computing systems relates to the types of processing that nodes are capable of performing. Specifically, in such conventional systems, each node is capable of processing only a single set of encoded instructions to perform a unit of work at a time. While such a conventional node may acquire different sets of encoded instructions over time and execute them to perform different types of work, such a node is not rendered capable of processing heterogeneous types of work in an overlapping time frame (or, for lack of a better term, concurrently). (The term “heterogeneous” is used herein to refer to processing tasks or units of work which are dissimilar or diverse in that they are performed by executing different sets of encoded instructions. Conversely, the term “homogeneous” is used to refer to processing tasks or units of work that are performed by executing the same set of encoded instructions. The term “set of instructions” is used herein to refer to any collection or body of related encoded instructions, such as a program, module, procedure, application, or other body, or portion thereof.)

In contrast with these conventional arrangements, embodiments of the invention provide a system wherein each node possesses the capability to concurrently perform heterogeneous units of work, such that a node may execute a first set of encoded instructions to process a first unit of work while also, in overlapping times or at another time, performing a second unit of work, heterogeneous with respect to the first unit of work, by executing a second set of instructions. This may be accomplished using any of numerous techniques. In accordance with some embodiments of the invention, a node is capable of implementing a plurality of application domains and isolating the execution of each of a plurality of bodies of instructions (hereinafter referred to as “handlers”) in a separate application domain to perform a particular unit of work. For example, a node may perform a first unit of work by executing a first handler in a first application domain and a second unit of work by executing a second handler in a second application domain. The node may create a processing thread for each handler and execute the processing threads concurrently, thereby concurrently performing heterogeneous units of work. In accordance with other embodiments of the invention, application domains may not be employed. For example, a node may create a processing thread for each of a plurality of handlers and execute the threads without employing application domains.

In some embodiments, each node is in network-based communication with a server system (which may comprise one or more physical computers) that assigns units of work to the node. The server system receives work from one or more client applications which are also in network-based communication with the server system. Each client application may communicate with the server system by means of an application programming interface (API) which allows the client application to provide work to the server. Work is provided in the form of a processing task, which the server system then divides into one or more units of work for distribution to one or more nodes on the grid.

In some embodiments, a client application may specify a “run model” for a particular processing task which defines, among other information, characteristics that a node should possess in order to be assigned a unit of work from the task. For example, the run model for a task may specify that in order to be assigned a unit of work, a node should possess certain processing capabilities and/or physical characteristics. For example, a run model may specify that a node must be capable of dedicating at least twenty percent of its total processing capacity to a unit of work or possess at least a minimum stated amount of random access memory (RAM) or a processor having a certain capability, such as speed. Any suitable characteristics and/or capabilities, for a node or otherwise, may be specified in a run model.

In some embodiments, the handler(s) executed to perform units of work in a processing task is(are) provided by the client application to the server system when the task is provided by the client application to the server system. For example, a particular task may comprise multiple heterogeneous units of work, and a handler for each unit of work may be provided by the client application to the server system for each unit of work. The server system may, for example, transmit the handler to a node along with the unit of work. If this proves inefficient, a node, at the time a unit of work is assigned to it, may determine whether it is already equipped with the correct handler(s) for performing the unit of work, and if not, the node may retrieve the required handler(s) (e.g., from the server system).

Some embodiments provide a system having the capability to segment audio data that forms the input to a speech recognition process prior to distribution to nodes on the grid. For example, pre-processing may be performed to divide audio input into a number of segments, preferably including creating a mathematical representation of each segment, to reduce the amount of data distributed to the grid and conserve network bandwidth. Preferably, audio input may be broken into segments based on natural speech boundaries rather than time boundaries, which can produce more accurate recognition results and help a speech recognition program detect sentence structure to facilitate more accurate recognition of some words.

In some embodiments, the system may optimize speech recognition processing by intelligently selecting nodes to perform particular units of work in a speech recognition processing task. For example, the server system may store information indicating the handlers with which certain nodes are equipped, the physical or logical characteristics of some or all nodes, and/or other information. Using this information and/or information provided by client applications relating to the processing task (e.g., a run model), the server system may distribute units of work involved in the processing task to node having the capability to process the units of work most efficiently.

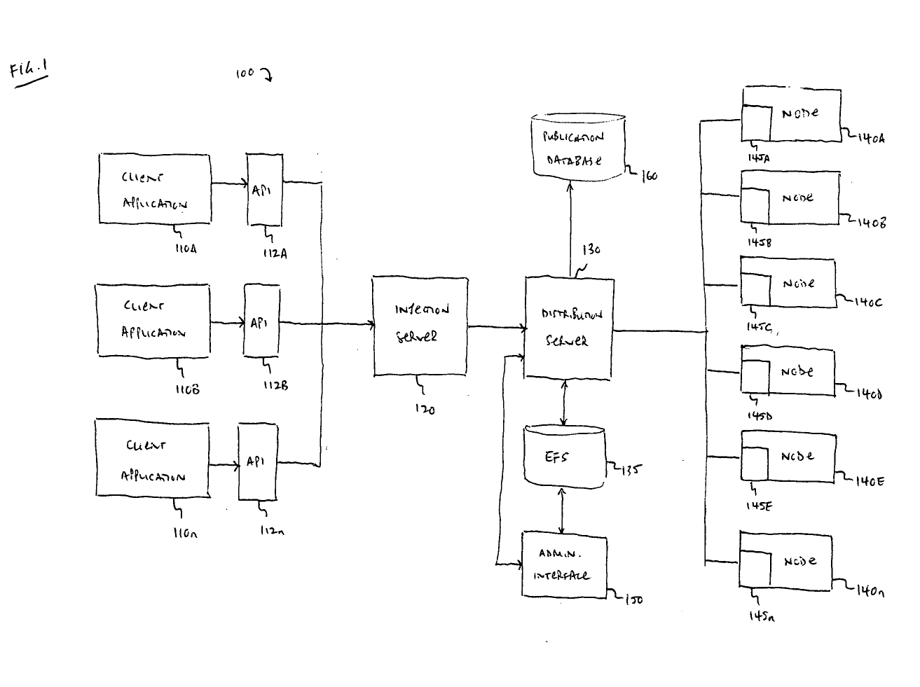

FIG. 1 depicts one example of a system configuration 100 in which aspects of the invention may be implemented. In certain implementations, system 100 may be employed to perform speech recognition processing, and much of the description provided below relates thereto. However, it should be appreciated that system 100 may be employed for any of numerous uses, and embodiments of the invention may be implemented in any of numerous ways. The invention is not limited in this respect.

In general, system 100 includes a plurality of client applications 110A-110n, each of which are capable of providing, via a respective API 112A-112n, one or more processing tasks to injection server 120. Injection server 120 divides each processing task received from client applications 110A-110n into one or more units of work, and provides the units of work to distribution server 130, which accesses information stored in electronic file storage (EFS) 135 in communicating with, and distributing work to, one or more nodes 140A-140n. Administration interface 150 enables users to access information stored in electronic file storage 135 or to add information thereto, such as to update the information, thereby indirectly changing the manner in which the distribution server assigns work to nodes 140A-140n.

An API 112 provides an interface by means of which a respective client application 110 may supply a processing task to the grid for completion. In some embodiments, a client application may specify a run model for a processing task which includes any suitable characteristic(s), from among a predetermined set of available characteristics, for a processing task and/or one or more nodes that process the unit(s) of work constituting the processing task. For example, a run model may specify that a node to be assigned a unit of work should be capable of processing at a minimum speed, possess a certain amount of storage capacity and/or memory and/or have a certain percentage of its processing capacity available to support that unit of work. A run model may also specify an initial priority for a processing task relative to other work in progress on the grid. Further, a run model may specify one or more rules for handling error conditions, such as failure by a node or an occurrence of a data exception.

Prior to dividing up a processing task, injection server 120 preferably ensures that it came from an authorized client so that only authorized work is supplied to the grid. For example, server 120 may compare an address (e.g., an internet protocol (IP) address) or other identifier for a client application attempting to inject a processing task into the queue with a list of addresses and/or other identifiers for clients authorized to do so. If a client's IP address is on the list, then the server may further request that the client supply a password which the server may verify before giving the client authorization to inject a processing task into the queue. Other security features may be substituted or added, as considered appropriate.

A processing task received by injection server 120 from a client application 110 may be divided into one or more units of work in any suitable fashion. As an example, injection server 120 may execute programmed instructions to divide data which is to be processed as part of a particular task into a number of portions, and each portion may become the subject of a unit of work. For example, in an implementation wherein speech recognition processing is performed, server 120 may divide audio data that comprises input to a speech recognition processing task into a plurality of segments prior to distribution of the segments to nodes on the grid.

Dividing audio data into segments may be performed in any of numerous ways. In some embodiments, an audio file can be divided into segments based upon natural speech boundaries, such as speaker turn (i.e., when one person engaged in a conversation stops speaking and another starts), the presence of a period of silence of predetermined length, speaker stress and/or a change in tempo. Dividing audio data in this manner is in contrast with conventional techniques, whereby audio is divided based on time boundaries, such as a fixed time period (e.g., thirty seconds of data).

Segmentation of audio data based on natural speech boundaries can achieve three important goals. First, it can minimize the processing required for a given quantity of audio data, by eliminating the need to process non-speech audio data. For example, a normal recorded conversation can contain up to thirty-five percent silence, so the removal of silence from a recorded conversation can significantly decrease the amount of processing required.

Second, removing silence can reduce the possibility of a falsely identified word. For example, background noise such as keyboard clicks and breathing can sometimes be falsely identified by a speech recognition program as a spoken word. As a result, removing silence can produce more accurate speech recognition results.

Third, segmentation based on natural speech boundaries rather than time boundaries can help a speech recognition program detect sentence structure, which can help the program recognize certain words. For example, many speech recognition programs employ language models which specify words that naturally precede or follow other words, as well as words which begin or end segments of speech. For example, for a speech sample containing the words, “How may I help you I need to ask about . . . ”, a language model may specify that this includes two discrete segments—specifically, “How may I help you” and “I need to ask about . . . ”—by recognizing that the words “you” and “I” are rarely spoken sequentially in a sentence in the English language, thus helping a speech recognition program correctly determine the words spoken in the sample. In contrast, when audio data is segmented according to time boundaries, a language model can be difficult to employ, as there may be unnatural speech breaks resulting from starting or stopping a segment at an arbitrary point. As a result, segmenting based on natural speech boundaries can improve the overall accuracy of speech recognition.

Injection server 120 may also process each segment to create a representation thereof for transmission and processing in place of the original segment, so as to minimize the amount of data distributed to the nodes on the grid and conserve network bandwidth. In some embodiments, a mathematical representation for each segment, such as a cepstrum, is created. Those skilled in the art will recognize that a cepstrum results from taking the Fourier transform of the decibel spectrum in a segment. In some embodiments, the decimal ranges in a cepstrum may be represented as a series of eight-or sixteen-bit fields, which may further reduce the amount of data in a segment.

To illustrate the usefulness of these features, it should be appreciated that an audio file representing a five-minute telephone call typically comprises about five megabytes of data, and that even a small call center may have hundreds of representatives performing telephone calls all day, every day. Thus, the amount of data typically generated by a call center can be substantial, such that minimizing the network bandwidth required to transport it (and processing to recognize and analyze it) may be very beneficial.

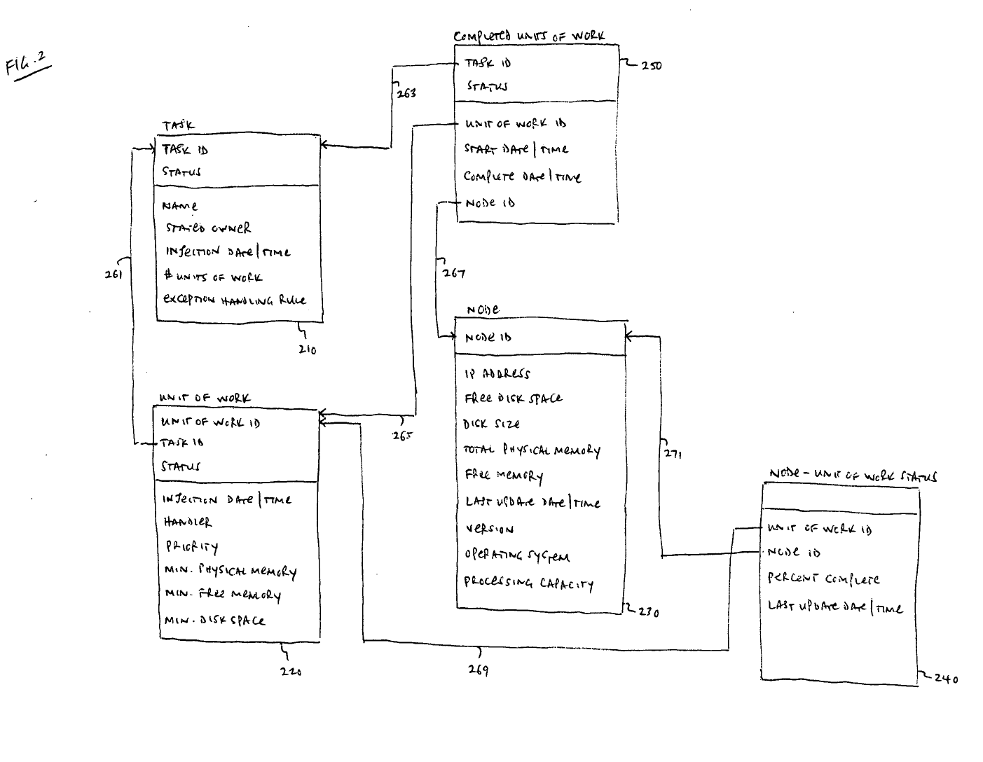

Upon dividing a processing task into one or more units of work, injection server 120 provides the units of work, as well as information on the processing task, to distribution server 130, which assigns work to one or more nodes 140. Distribution server 130 maintains the information provided by injection server 120, as well as information provided by all nodes 140 on the system, in electronic file storage 135 (which may comprise any suitable storage facility, including memory such as RAM), and employs this information in assigning units of work to one or more nodes 140. This information is described in further detail below with reference to FIG. 2.

Distribution server 130 communicates with each node 140 via one or more networks. Communication may be performed according to any suitable communications protocol, such as via transmission control protocol (TCP) sockets or another protocol, and may be encrypted, such as via the MD5 encryption algorithm or another encryption algorithm. Communication may be accomplished using any suitable components and/or infrastructure.

In the embodiment of FIG. 1, each node 140 includes a component 145 which facilitates communication with distribution server 130. In embodiments wherein node 140 is a computer executing a Microsoft Windows®-family operating system offered by Microsoft® Corporation of Redmond, Wash., component 145 may be implemented as a Windows® service, which is an implementation technique well-known to those skilled in software engineering. In general, a Windows® service is an executable program built into the operating system that may be configured to perform any number of tasks, such as communicating with an external entity (e.g., distribution server 130), upon the occurrence of a predetermined event. For example, in the embodiment of FIG. 1, component 145 is configured to start when the operating system on its associated node 140 initiates (e.g., when the computer constituting node 140 is started), access a configuration file maintained in memory on such node 140 that specifies the network address (e.g., IP address) of distribution server 130, and send a message to distribution server 130 indicating that node 140 is available to be assigned work. In some embodiments, upon receiving such a registration message from node 140, distribution server 130 sends an acknowledgement message to node 140.

Implementation of component 145 as a Windows® service may offer advantages over other implementations, such as those wherein component 145 comprises a screen saver or another type of application executing on node 140. For example, when implemented as a Windows® service, component 145 may take greater advantage of idle time during times when node 140 is not being used than will a screen saver application. While a screen saver typically is configured to start after a prolonged period of node idle time, a Windows® service may be configured to start after a much shorter period, such as thirty seconds of idle time (or less), and thus can provide more processing capacity to the grid.

Despite this advantage, it should be appreciated that component 145 need not be implemented as a Windows® service, and may take any suitable form. Indeed, node 140 may execute any suitable operating system, and is not limited to a Windows®-family operating system. Embodiments of the invention are not limited to implementation via any particular platform(s) or component(s).

In some embodiments, when component 145 sends a message to distribution server 130, it communicates information describing the current status and characteristics of the node 140 on which the component 145 resides. This information may include, for example, indications of the node's current CPU type and/or speed, free memory, free disk space, operating system, total disk space, total memory, CPU load, and/or other information. In some embodiments, an updated version of this information may be sent whenever node 140 sends a message to distribution server 130, such as when the node 140 registers its availability for work, when distribution server 130 acknowledges the node's registration, and/or when the distribution server 130 and node 140 communicate during the active processing of work. The information provided by node 140 may be stored by distribution server 130 in electronic file storage 135, along with the information provided by injection server 120 (described above) that relates to processing tasks and units of work. In some embodiments, distribution server 130 employs the information stored in electronic file storage 135 to manage the assignment of work to nodes 140.

Electronic file storage 135 may include, for example, a database or any other suitable mechanism(s) for storing this information. A simplified schema, or data structure, for an example of a relational database for storing the information is shown in FIG. 2. The schema of FIG. 2 includes representations of several related tables (210-250) which store information on nodes, processing tasks, units of work, or a combination thereof. Each of these tables is described below with reference to the source of the information stored therein. As with most relational databases, the tables in the schema of FIG. 2 share common data elements, stored in table columns, whose consistency (i.e., relational integrity) is maintained through the use of foreign keys.

Task table 210 stores information related to processing tasks. The information stored in table 210 is provided initially by injection server 120, and updated as the considered task is performed by nodes on the grid. Task table 210 includes a plurality of fields (e.g., columns) which respectively store an indication of a task name, stated owner (e.g., a client application 110), date and time of injection, number of units of work included and exception handling rule, all of which is supplied by injection server 120. Task table 210 also includes a field (e.g., column) storing a status indicator which specifies the current status of the task. This information is derived based on information provided by nodes while the task is being processed.

Unit of work table 220 stores information related to units of work. As with task table 210, the information stored in unit of work table 220 is provided initially by injection server 120 and updated as the considered unit of work is performed by a node on the grid. Unit of work table 220 includes a plurality of fields which respectively store an indication of an identifier for the unit of work, the processing task with which it is associated (having a foreign key 261 to the task identifier stored in task table 210), date and time of injection, required handler, priority, minimum node physical memory required for processing, free node memory required for processing, and disk space required, all of which is supplied by injection server 120. Unit of work table 220 also includes fields which each store an assigned node identifier and status indicator which specifies the current status of the unit of work. The node identifier is assigned by distribution server 130 when the node registers its availability for work. The status information is provided by the node to which the unit of work is assigned.

Node information table 230 stores information relating to nodes on the grid. Node information table 230 includes a plurality of fields which respectively store information such as, for example, an indication of the node identifier, its IP address, free disk space, disk size, total physical memory, free memory, the date and time information on the node was last updated, installed version of component 145, operating system and processing capacity (e.g., expressed in terms of megaflops). The information stored in this table is provided or updated by individual nodes as those nodes communicate with distribution server 130.

Node-unit of work status table 240 stores information relating to the status of individual units of work being processed by nodes. The information stored in this table is provided by individual nodes as those nodes perform units of work. Node-unit of work table 240 may include a plurality of fields which respectively store an indication of a unit of work identifier (having a foreign key 269 to the unit of work identifier stored in unit of work table 220), node identifier (having a foreign key 271 to the node identifier stored in node information table 230), percent complete (e.g., specified by the node performing the unit of work), and the date and time that the status information was last updated.

Completed units of work table 250 stores information relating to units of work that have been successfully performed by nodes on the grid. The table may include a plurality of fields which respectively store an indication of a unit of work identifier (having a foreign key 265 to the unit of work identifier stored in unit of work table 220), task identifier (having a foreign key 263 to the task identifier stored in task table 210), date and time started, date and time completed and node identifier.

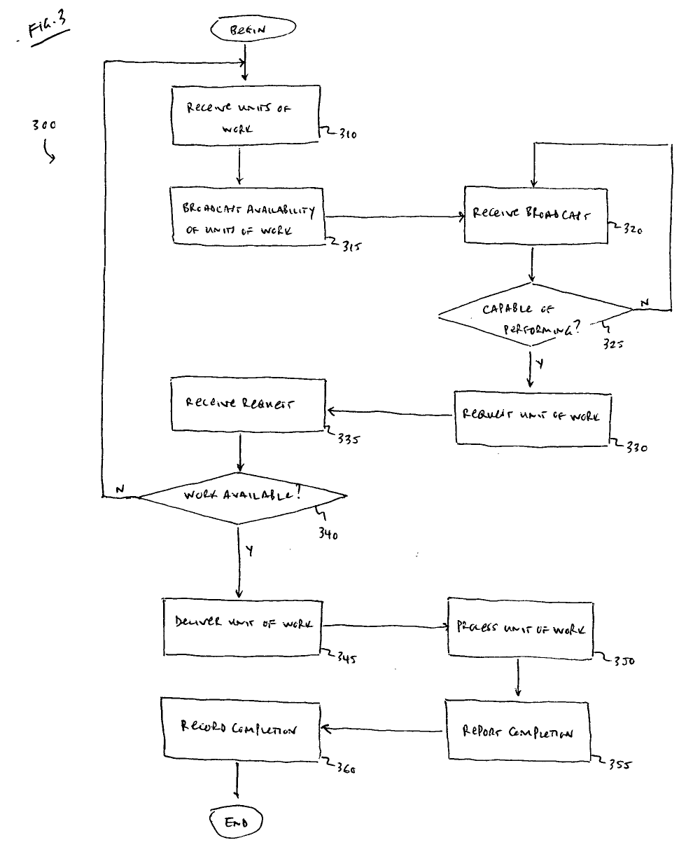

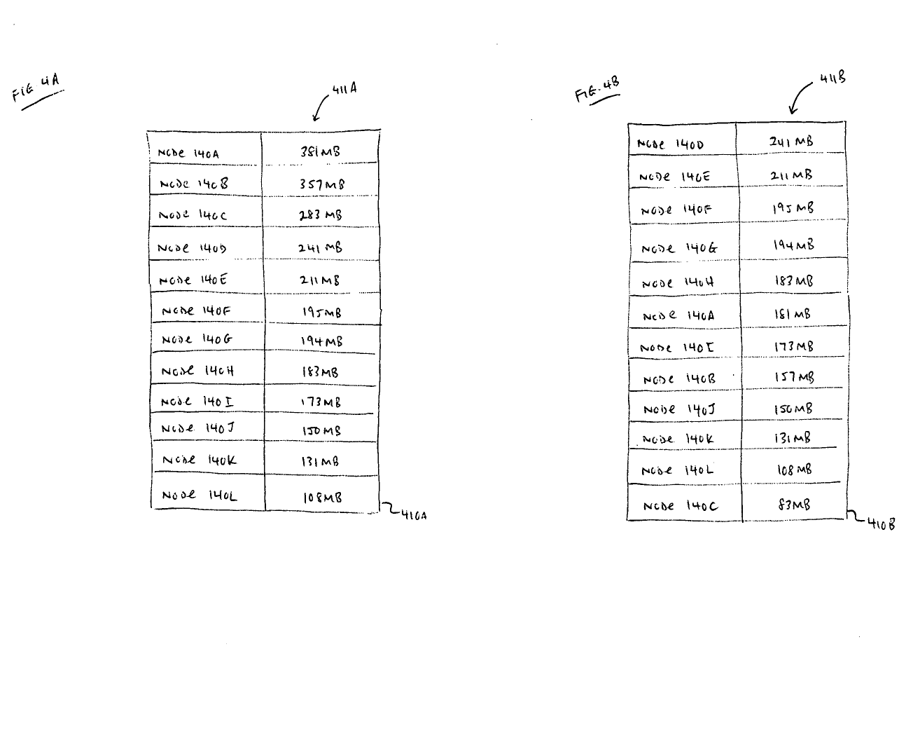

Distribution server 130 accesses and updates the information stored in electronic file storage 135 (e.g., the database represented in FIG. 2) in assigning work to nodes and tracking the completion of that work. An example of a process executed by distribution server 130 to assign units of work to nodes is described below with reference to FIGS. 3 and 4A-4B.

At the start of process 300 (FIG. 3), units of work which are ready for distribution on the grid are received at distribution server 130 in act 310. These may be provided, for example, by injection server 120, and an indication thereof may be loaded by distribution server 130 into unit of work table 220. For the purpose of this example, assume that three units of work have been injected and that injection server 120 has specified that each unit of work requires 200 megabytes (MB) of free memory.

Distribution server 130 may then broadcast the availability of the units of work to one or more nodes in act 315. In some embodiments, the availability of work is broadcast only to those nodes which distribution server 130 determines to have the capacity to perform the work, so as to minimize network traffic. This determination may be made, for example, by applying an algorithm (e.g., embodied in a set of encoded instructions) which takes into account one or more node characteristics (e.g., determined by accessing node information table 230) to determine those which have the capacity to perform the work.

In the example described below, distribution server 130 determines the nodes that should receive the broadcast by identifying the nodes which have a sufficient amount of free memory—in this case, 200 MB or more of free memory.

To determine the nodes having a sufficient amount of free memory, distribution server 130 may query node information table 230 to construct table 410A shown in FIG. 4A. Table 410A contains a sorted list of the twelve nodes that have registered their availability for work to distribution server 130. More specifically, table 410A contains a list which is sorted according to the amount of free memory on each registered node, shown in column 411A. As can be seen in table 410A, five nodes (140A-140E) each have more than 200 MB of free memory.

Distribution server 130 may broadcast to any or all of nodes 140A-140E, and may apply any algorithm or criteria in selecting which nodes receive the broadcast. For example, distribution server 130 may broadcast to all of nodes 140A-140E and assign the work to those nodes which respond with a request for the work most quickly. Alternatively, distribution server 130 may broadcast to the three nodes (140A-140C) having the most free memory available, and if any one or more of these nodes do(es) not respond to the broadcast, the distribution server may continue down the list. Any suitable algorithm or criteria may be employed to determine which nodes receive the broadcast, as the invention is not limited to any particular implementation. In this example, assume that distribution server 130 broadcasts to each of nodes 140A-140E in act 315.

In act 320, the selected nodes receive the broadcast. The broadcast message may indicate the work's availability and the amount of free memory required to perform it.

In act 325, each node receiving the broadcast determines whether it has the amount of free memory that is required to perform the work. For example, component 145 (FIG. 1) may determine whether sufficient memory is available on the node. The node may not have sufficient memory, for example, because it has begun new processing since it last communicated its free memory to distribution server 130 (i.e. the indication stored in node information table 230 may be outdated). If the node is not capable of handling the work, it does not respond to distribution server 130. If the node is capable of handling the work, the process proceeds to act 330, wherein the node requests a unit of work.

In act 335, distribution server 130 receives the node's request, and in act 340 it determines whether work is available. Work may not be available, for example, because the node requesting the work is not one of the first three to respond to the broadcast sent in act 315, such that the work has already been assigned. If it is determined in act 340 that the work is not available, the server does not respond to the node, and may, for example, return to act 310.

If it is determined in act 340 that the work is available, distribution server 130 provides the work to the node in act 345.

It should be appreciated that although work is distributed in this example based on the order in which requests for work are received at the distribution server, work need not be distributed in this manner. Any suitable algorithm or criteria may be employed to determine which of the nodes that respond to the broadcast receive the work. For example, the distribution server may wait to see which of the nodes responds to the broadcast within a predetermined period, and then select which of the responding nodes receives the work by applying an algorithm or one or more selection criteria.

Referring again to this example, when each of the three units of work have been distributed to nodes, distribution server 130 updates the information stored in table 410A shown in FIG. 4A to produce table 410B shown in FIG. 4B. For the sake of this example, assume that nodes 140A-140C responded first to the broadcast and were assigned the three units of work. As a result, the information in table 410B reflects that each of nodes 140A-140C has 200 MB less memory free than that which is shown in table 410A, such that the list of nodes is ordered differently. As a result, when more units of work are provided to distribution server 130 by injection server 120, and the preceding steps in process 300 are re-executed to determine the nodes to which a broadcast indicating the availability of work should be sent, different nodes will receive the broadcast. For example, if three more units of work requiring 200 MB of free memory become available, only nodes 140D and 140E will receive the broadcast, at least immediately. Distribution server 130 may then wait until another node sends a message in which it indicates that it has at least 200 MB of free memory, and then send a broadcast to that node, as well, indicating the availability of the unit of work.

Referring again to FIG. 3, in act 350 the node processes the unit of work, then reports its completion to distribution server in act 355 (e.g., in a message which also communicates the node's current status and characteristics, so that this information may be loaded to node information table 230). Distribution server 130 records the completion of the unit of work in act 360 (e.g., by updating information stored in unit of work table 220, task table 210 and/or completed units of work table 250). These acts are described in further detail below.

Upon the completion of act 360, process 300 completes.

It should be appreciated that the method described above for selecting nodes that receive units of work is merely exemplary, and that numerous other techniques may be performed to optimize grid processing by intelligently selecting nodes for performing units of work. For example, distribution server 130 may select nodes based on the handler(s) installed thereon, processing and/or memory capabilities, other physical or logical characteristics, or a combination thereof. As an example, the process described above with reference to FIGS. 3 and 4A-4B could be modified so that distribution server 130 selects the nodes that will receive the broadcast of the availability of units of work based on several factors, such as the amount of free memory on each node and the presence of a handler on each node which is required to perform the units of work.

Distribution server 130 may distribute work to nodes based on any suitable algorithm, which algorithm may take into account any of numerous factors or combinations thereof. As an example, if a task requires relatively little processing capacity and all nodes are already operating at full capacity, and only a few nodes have the required handler application installed, then the server may wait until those nodes have capacity and then assign the work to them. Conversely, if distribution server 130 determines that the nodes with the handler application installed are operating at full capacity and others without it are idle, then the server may assign the work to the idle nodes, such that those nodes will be required to acquire and install the handler application before processing can begin. Any suitable algorithm may be employed by the server for determining node capabilities (e.g., memory, processor type and speed, processor load level, etc.) and for correspondingly distributing work. As such, the invention is not limited to a specific algorithm. Suitable algorithms can readily be devised and implemented from this description by those skilled in the computer processing and/or networking arts.

Units of work may also be distributed based upon the amount of input data involved in a particular unit of work or task. For example, if the amount of input for each unit of work in a task is substantial, the server may determine (e.g., based on one or more algorithms) that the units of work would be most efficiently processed if distributed to a large number of nodes so that each performs a single unit of work. However, if the input data for each unit of work is small (e.g., below a certain threshold), the server may assign all of the units of work to a single node, especially if that node is idle and all others are busy processing other work. Of course, it is a matter of design as to how tasks are labeled or analyzed as to the amount of data involved, memory needed, priority, processor load to be generated, and so forth; and as to how the work is distributed in response to analyzing such information. Processing may be performed in any suitable fashion, as the invention is not limited in this respect.

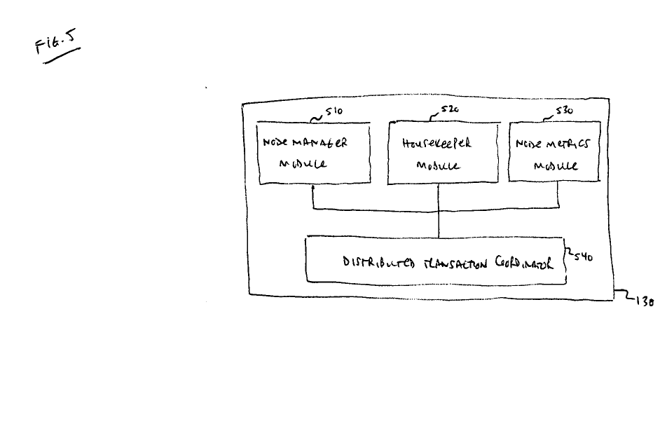

FIG. 5 depicts modules that may be implemented (e.g., via software) on distribution server 130 for the management of communication with nodes 140 on the grid. These modules include node manager module 510, housekeeper module 520, node metrics module 530 and distributed transaction coordinator 540. In other implementations, one or more of these modules may not be required, modules may be combined, or other modules may be substituted. The function of each module is described below without regard to a specific implementation, as those skilled in the art will be able to create appropriate software code from a functional description.

Node manager module 510 receives and manages information received from nodes on the grid. As described above, this information may provide an indication of various node characteristics, such as its processing capacity, free memory, free disk space, and/or other node characteristics that will be useful in assessing what tasks, if any, may be assigned to the node. Upon receiving information from one or more nodes 140, node manager module 210 may cause any or all of the information to be stored in electronic file storage 135, such as in node information table 230 shown in FIG. 2.

Housekeeper module 520 monitors whether information is received from each node. For example, in some embodiments if information is not received from a certain node 140 within a defined period (e.g., as defined by information stored in the “date and time last updated” column in node information table 230), housekeeper 520 may cancel and reassign units of work in process on that node. For example, housekeeper 520 may update information stored in unit of work table 220 to reflect that the considered node is no longer assigned to a unit of work, and if the node thereafter resumes communication with the server, housekeeper 520 may issue an instruction to cancel the work in process.

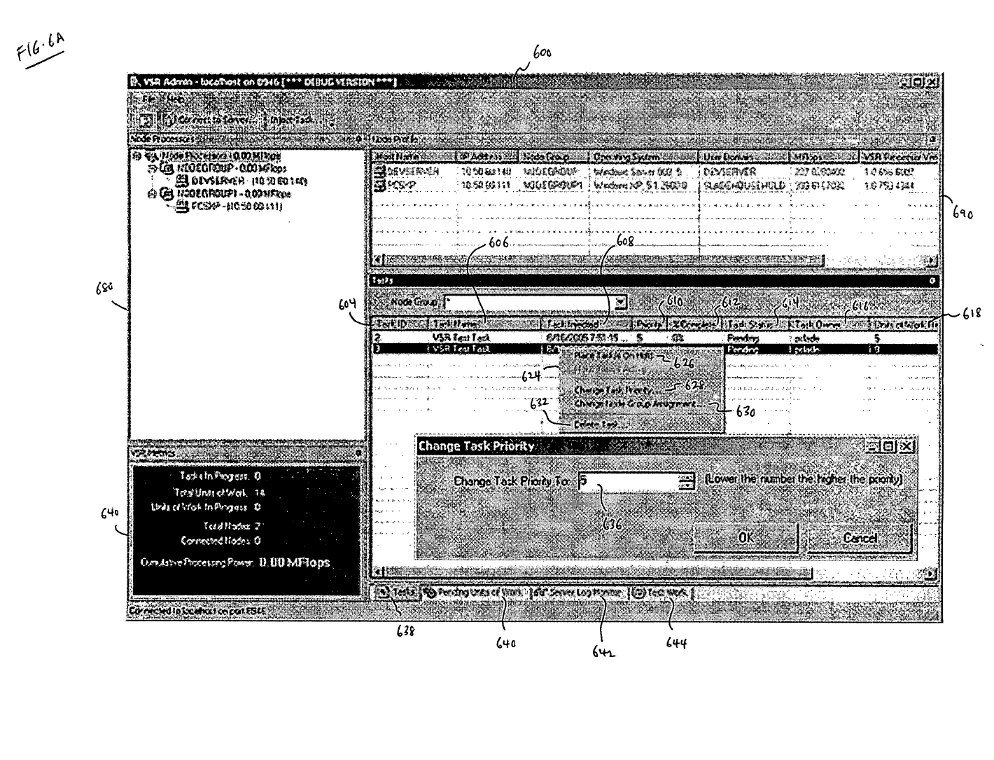

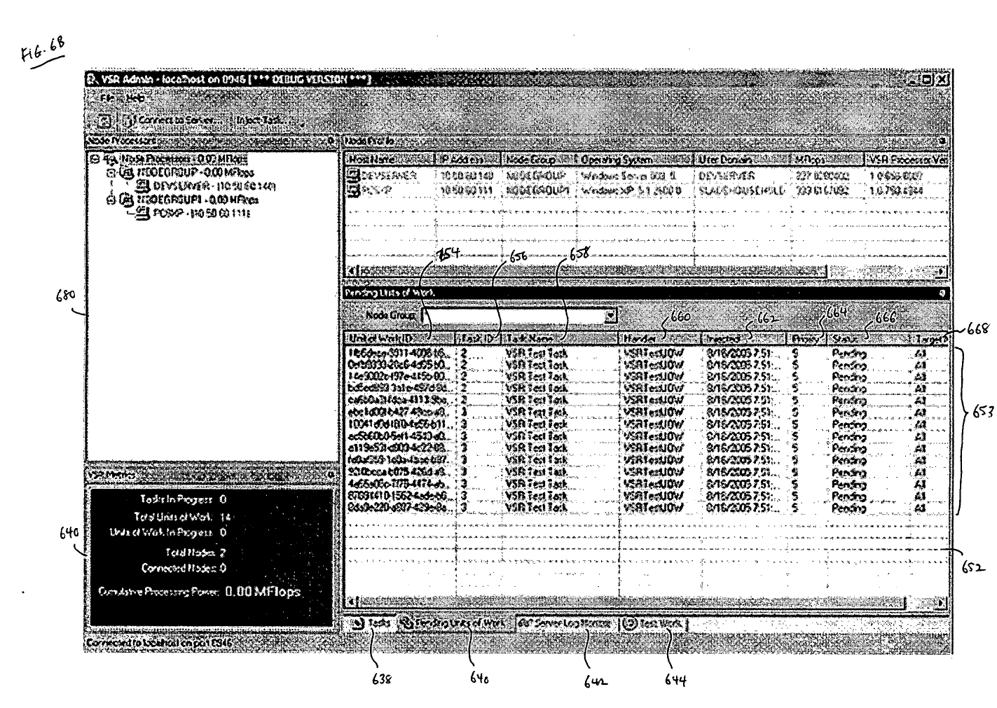

Distributed transaction coordinator module 530 enables a user to employ administration interface 130 (FIG. 1) to gather information on units of work in process on the grid and/or change the manner in which those units of work are assigned or completed. For example, a user may employ administration interface 130 to view a representation of ongoing processing on the grid, and administration interface 130 may accept input from the user to change the manner in which that processing occurs. FIGS. 6A and 6B depict two alternative examples of screen embodiments of administration interface 130. Specifically, FIG. 6A depicts interface screen 600 and FIG. 6B depicts interface screen 650, which share common elements but also present slightly different information to a user. Interface screens 600 and 650 present information stored in electronic file storage 135 (e.g., in a database characterized by the schema shown in FIG. 2).

Interface screen 600 allows a user to view ongoing tasks, and change a priority which is assigned to selected tasks by injection server 120. Interface screen 600 includes portion 640, which shows a summary of work occurring on the grid, including the number of tasks and units of work in progress, the number of nodes, and the total processing capacity by the nodes. Portion 602 presents information on individual tasks in tabular form. Table entries 620 and 622 each contain information arranged, in this example, in columns 604 (“Task ID”), 606 (“Task Name”), 608 (“Task Injected”), 610 (“Priority”), 612 (“% Complete”), 614 (“Task Status”), 616 (“Task Owner”) and 618 (“Units Of Work Required”).

Using interface 6A, a user may select a particular table entry in portion 602 and modify the manner in which the task is performed. For example, a user may highlight and right-click table entry 622 as shown, and provide input relating to the task in this entry. Input options are represented by items 626 (“Place Tasks On Hold”), 628 (“Change Task Priority”), 630 (“Change Node Group Assignment”) and 632 (“Delete Task”). In the example shown, a user has selected list item 628, causing dialog box 634, allowing the user to change the priority of the selected task, to appear. The user may change the priority by providing input (e.g., via keyboard or mouse) to box 636.

Interface 600 includes tabs 638 (“Tasks”), 640 (“Pending Units of Work”), 642 (“Server Log Monitor”) and 644 (“Test Work”). Tab 638 visually indicates that a user has selected it so as to view information relating to tasks.

By selecting tab 640, a user may view information on units of work, as shown in interface screen 650 in FIG. 6B. This information is also shown in tabular form. Data on each table entry 653 is contained in columns 654 (“Unit Of Work ID”), 656 (“Task ID”), 658 (“Task Name”), 660 (“Handler”), 662 (“Injected”), 664 (“Priority”), 666 (“Status”) and 668 (“Target Node”). Although not shown in screen 650, a user may provide input relating to any of the units of work shown in the table. For example, in a manner similar to that described above with reference to FIG. 6A, a user may select a table entry corresponding to a unit of work, right-click on the entry to expose a number of input options, and select one of the options to provide input. For example, a user may provide input to change the priority of a particular unit of work. Any suitable input may be provided to modify any characteristic of a unit of work, as the invention is not limited in this respect.

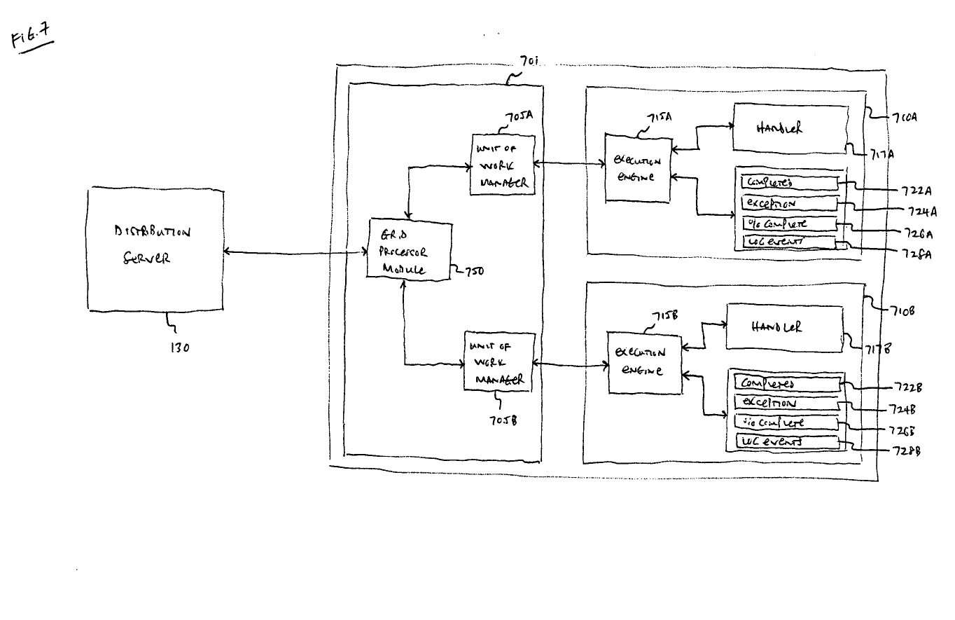

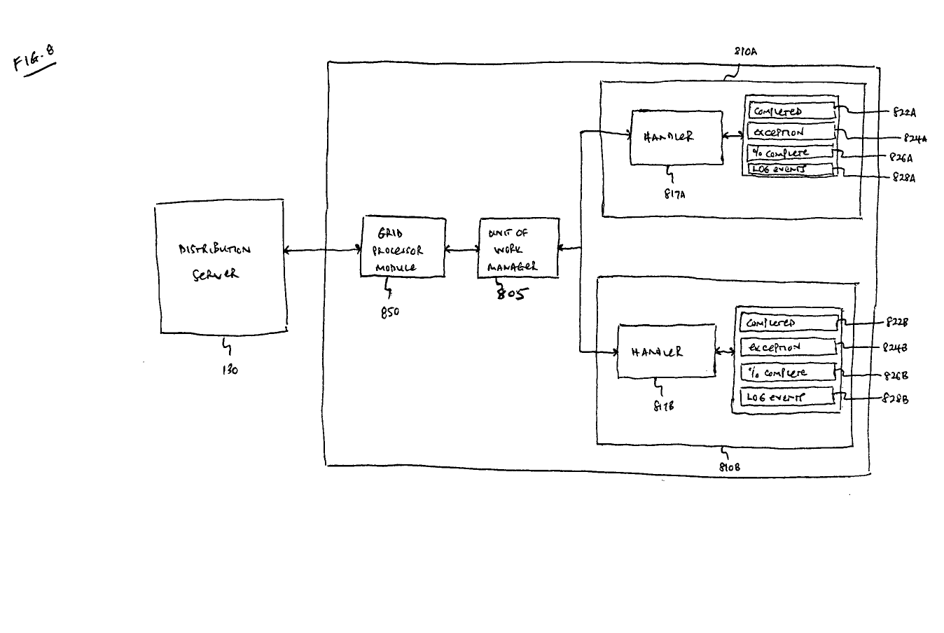

FIGS. 7 and 8 illustrate examples of processing techniques which may be employed on a node 140 to concurrently perform multiple units of work. As described above, a node may be capable of concurrently executing each of a plurality of handlers in a different application domain, or performing such processing without employing application domains. FIG. 7 depicts a processing technique which uses application domains, and FIG. 8 depicts a technique wherein application domains are not employed.

At a high level, the technique shown in FIG. 7 involves grid processor module 750 receiving one or more units of work from distribution server 130, and employing unit of work manager 705 (e.g., 705A) to communicate with an execution engine 715 (e.g., 715A) in an application domain 710 (e.g., 710A). Processing of a unit of work occurs via the execution of a handler 717 (e.g., 717A) in the application domain 710. Processing in one application domain 710 occurs independently of, and segregated from, processing in other application domains 710. A body of instructions executed in an application domain may be prevented from accessing data, code libraries or other resources. This type of segregation may be useful, for example, where the behavior of an application or the outcome of its execution is unknown. For example, it may be useful to employ application domains when code provided by an unfamiliar party is used, so as to ensure that the code's execution does not result in a corruption of data used by other applications.

Those skilled in the art of software engineering will recognize that using application domains involves employing conventional techniques. In general, application domains offer an alternative to previous techniques wherein applications were each loaded to separate processes, imposing performance overhead in the form of cross-process calls and process switching. Using application domains, the execution of each application may be isolated such that an application is not able to access data and resources allocated to another application, a failure of one application does not affect the execution of others, and one application may be stopped without stopping other applications.

In accordance with some embodiments, the assignment of a unit of work involves a transmission by distribution server 130 to node 140, and more particularly to grid processor 750, of various information related to the unit of work. Specifically, the information may include the input data for the unit of work, and an indication of the handler that is required to perform the unit of work. Upon receiving this information, grid processor 750 determines whether the required handler exists on the node, and if so, it establishes an application domain 710 to process the unit of work using that handler. If grid processor 750 determines that the required handler does not exist on the node, it requests the required handler from distribution server 130. Upon receiving the handler, grid processor 750 establishes a new application domain, such as by employing conventional techniques, and causes the handler to be loaded to that application domain so that the unit of work may be performed therein.

In some embodiments, processing in each application domain may be performed using processing threads. Those skilled in the art of software engineering will recognize that employing processing threads also involves conventional techniques. In general, a processing thread involves processing multiple streams (i.e., threads) of programmed instructions (e.g., those being executed in each application domain) in parallel, such that multiple threads are being processed concurrently. In a threaded operation, the operating system (usually a multi-tasking operating system) switches between instructions in the threads to keep all threads in process. Of course, threading may be unnecessary. In a multi-processor or multi-core situation, of course, a unit of work may be assigned to a processor or core (to the exclusion of other units of work) and true parallel multi-tasking may be achieved.

In some embodiments, upon receiving a unit of work from the distribution server and identifying or establishing an application domain as appropriate, grid processor 750 creates a processing thread and causes responsibility for the thread to be assumed by an execution engine 715 (e.g., 715A) in an application domain (e.g., 710A). Execution engine 715 then begins a new thread, in which processing prerequisites for the unit of work are satisfied. For example, code which may be required to perform the unit of work, such as modules 722A-728A shown in FIG. 7 or input data which is the subject of the unit of work, may be loaded into the application domain 710. After processing prerequisites are satisfied, execution engine 715 causes the programmed instructions which constitute the handler 717A to be executed within the thread.

Any or all of modules 722-728 in an application domain 710 may be called to provide information related to the execution of the unit of work to distribution server 130. Specifically, module 722 is called to report the completion of the unit of work, module 724 is called when a processing exception (e.g., an abnormal termination or unexpected data condition) occurs, module 726 generates information on the node's progress in completing the unit of work, and module 728 is called to generate log information which may be stored in electronic file storage 135 (e.g., in completed unit of work table 250). These modules may be called, for example, by programmed instructions in handler 717.

In some embodiments, if module 724 is called to report a processing exception, upon receiving the notification generated thereby, distribution server 130 may reassign the unit of work to another node. For example, distribution server 130 may update unit of work table 220 to remove an indication of an assignment of the unit of work to the considered node, and perform the processes described above with reference to FIGS. 3 and 4A-4B to reassign the unit of work to another node.

In some embodiments, when a unit of work completes, the appropriate execution engine 715 (for the application domain in which the unit of work was executed) sends a notification via unit of work manager 705 and grid processor 750 to distribution server 130.

The processing technique illustrated in FIG. 8 is similar to that which is shown in FIG. 7, except that application domains are not employed. In this example, processing threads are employed, such that each handler is executed in a separate thread, but application domains are not employed. Because of this, handlers executed in different threads may share data, code libraries and/or other resources, if desired.

In the example shown, when a unit of work is received from distribution server 130, and the appropriate handler is either determined to reside on the node or is acquired from distribution server 130, grid processor module 850 instructs unit of work manager 805 to create a new processing thread 810 (e.g., 810A) in which the handler will be executed. More specifically, unit of work manager 805 creates objects representing instances of handler 817 (e.g., 817A) and modules 822-828 (e.g., 822A-828A), and causes instructions in these instances to be executed within the thread. As the instructions are executed within the thread, the unit of work is performed, and information relating to its performance may be provided to distribution server 130 in a manner similar to that which is described with reference to FIG. 7.

As shown in FIG. 8, multiple processing threads 810 (e.g., 810A and 810B) may execute concurrently on node 140. As described above, the operating system on the node may switch between instructions in threads 810A and 810B to keep both threads in process. Although only two threads 810 are shown in FIG. 8, any suitable number of threads may be in process at one time, as the invention is not limited in this respect. In some embodiments, when the processing in a thread completes, unit of work manager 805 sends notification via grid processor module 750 to distribution server 130.

Because the technique shown in FIG. 8 involves creating an instance of a handler to execute within a particular thread, and because threaded processes (unlike those executing in application domains) may share data, code libraries and/or other resources, the processing technique shown in FIG. 8 may allow not only for concurrent execution of heterogeneous units of work, but also concurrent execution of homogeneous units of work. For example, a first instance of a given handler may be executed within thread 810A, a second instance of the same handler may be executed within thread 810B, and each may access an instance of the same code library during execution. In contrast, when application domains are employed to concurrently perform units of work, because handlers in different application domains may not be capable of sharing code, two instances of the same handler may not be capable of executing in separate application domains at the same time, and so units of work performed concurrently may be required to be heterogeneous. Thus, the processing technique shown in FIG. 8 may be useful where homogeneous units of work are to be concurrently performed. Of course, other processing techniques which allow for concurrent processing of homogeneous units of work may alternatively be employed, as the invention is not limited to any particular implementation.

As described above, embodiments of the invention may improve the ability of grid computing systems to perform speech recognition processing. Accordingly, the performance a unit of work by a node may involve processing a segment of audio data to generate a representation of words spoken in the segment, such as by executing a handler (e.g., handler 717 or 817) designed for such processing. Speech recognition processing may be performed in any suitable fashion, as the invention is not limited to any particular implementation. One example of a technique is described in commonly assigned U.S. patent application Ser. No. 10/672,767, entitled “Software for Statistical Analysis of Speech,” which is incorporated herein by reference.

It should be appreciated that the embodiments described with reference to FIGS. 7 and 8 are merely illustrative, and that other embodiments may be implemented in any of numerous ways. For example, processing on a node need not be threaded, and application domains need not be employed. In embodiments wherein a node is capable of concurrently processing multiple units of work, any suitable technique may be employed to concurrently execute applications or other bodies of instructions.

It should be appreciated that providing the capability for nodes on the grid to concurrently execute multiple units of work provides many advantages, several of which allow the system to provide improved speech recognition processing. For example, different units of work executed concurrently on a given node may involve the execution of different handlers, such as different versions of the same speech recognition program. For example, each speech recognition program may be designed for a different language (e.g., one for English, another for Spanish). Alternatively, different handlers may comprise different program types (e.g., one may be a speech recognition program, and another may be an audio pre-processing program). In certain embodiments, the amount of parallelization is controlled by the amount and type of available resources on the machine, such as the number of CPU's. However, in certain embodiments, multiple tasks may be started on a machine having a single CPU to take advantage of resource bottlenecks or wait-states for one task (e.g., loading a language model to disk).

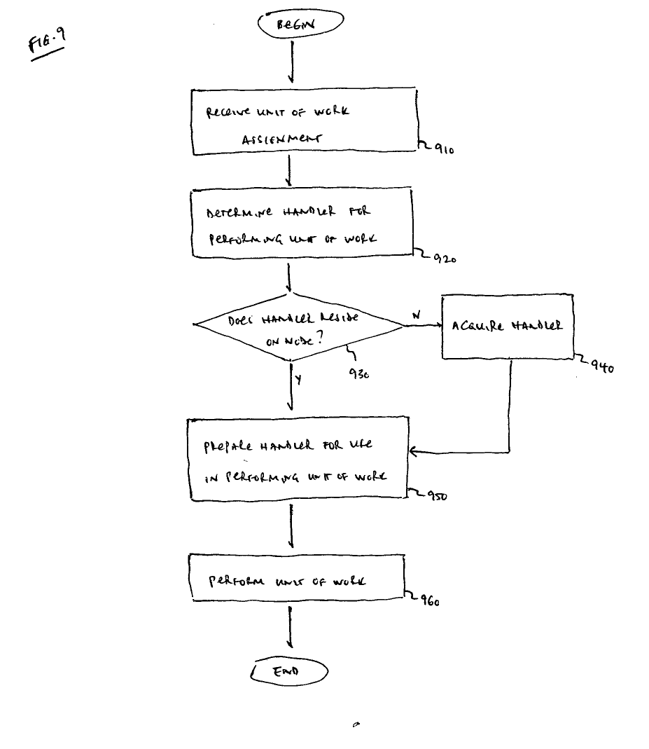

As described above, at the time a unit of work is assigned to a node, the node may determine whether the appropriate handler for performing the unit of work resides on the node, and if it does not, the node may dynamically acquire the handler to perform the unit of work. FIG. 9 depicts one example of a process 900 executed by a node to dynamically acquire a handler for performing a unit of work.

Upon the start of process 900, the node 140 receives a unit of work assignment, such as from distribution server 130, in act 910. The assignment may include information such as the input data which is to be processed in performing the unit of work, the handler required to perform the unit of work, and/or other information. Based on this information, in act 920 the node determines the required handler, and in act 930 determines whether the required handler exists on (e.g., has previously been loaded to) the node. This may be performed in any suitable fashion, such as by examining an inventory of handlers on the node.

If it is determined that the required handler does not exist on the node, then the node retrieve the required handler in act 940. For example, the node may issue a request to distribution server 130 to send the handler to the node, and distribution server 130 may respond to the node with the handler. Alternatively, the node may directly access a database (e.g., electronic file storage 135, FIG. 1) to retrieve the handler. Any suitable technique for providing the handler to the node may be employed. Distribution server 130 may store an indication that the handler has been provided to the node in electronic file storage 135.

Upon the completion of act 940, or upon determining in act 930 that the required handler exists on the node, the process proceeds to act 950, wherein the node prepares the handler for use in performing the unit of work. For example, as described above, the node may load the handler to an application domain so that the processing associated with performing the unit of work may be isolated from other processing performed on the node. In act 960, the node performs the unit of work using the acquired handler. Upon the completion of act 960, process 900 ends.

It should also be appreciated that because a node is capable of determining whether it has the appropriate handler to perform a unit of work, the node is capable of dynamically acquiring the capability to process speech data in a manner defined by a user. For example, at the time unit of work is assigned to a particular node on the grid, the node may dynamically acquire the capability to perform that unit of work in a manner which complies with the user's specifications, as well as instructions on how the handler should be implemented (e.g., how it should be launched), and how the output generated thereby should be handled.

This feature may allow nodes on the grid to be functionally scaleable, and to flexibly adapt to changing needs of the user. For example, if a user that previously employed the system to process speech in a first language wishes to process speech in a second language, the user may develop a handler designed for the second language and, as units of work involving the second language are assigned to nodes, they may automatically acquire the capability to process speech in the second language. This feature obviates the need to take nodes offline to install new software (thereby minimizing administration expense), and may distribute functionality to nodes on an as-needed basis (thereby eliminating the need for nodes that do not use the handler application to store it). In a given implementation, at the time of system design, a protocol presumably will be selected or designed to permit appropriate communication between a server and nodes, so as to facilitate a node signaling its capabilities and needs and a server recognizing and responding to that information by providing required handler applications stored in a memory at the server or accessible by the server. The details of such a protocol can be readily devised by those skilled in computer processing and/or networking, and the details of suitable protocols are not discussed herein in order to avoid obfuscating the invention.

This feature may also be advantageous in a speech recognition context in that this type of processing typically involves multiple processing passes, wherein the output of one step constitutes the input for the next. For example, one example of a speech recognition process may involve a first step wherein an audio file is segmented and a representation for each segment is created, a second step wherein a speech recognition program is executed on the results of the first step, a third step wherein the results generated during the second step are combined, and a fourth step wherein pattern recognition is performed on the results of the third step. Changes to program code for any one step can necessitate changes to other steps, as different input may be provided to a particular step, and the input may require different processing. As a result, the ability of a node to adapt flexibly to changing requirements can save considerable administration costs.

In some embodiments, upon the completion of a unit of work by a node 140, the node sends a notification to distribution server 130, as well as the results generated in the performance of the unit of work. For example, if the unit of work involves performing speech recognition processing on a segment of audio data, the results may include data (e.g., text) representing the words recognized in the audio data. Upon receiving notification that the unit of work has completed, distribution server 130 may update information stored in electronic file storage 135 (e.g., stored in unit of work table 220, node-unit of work table 240, and/or completed unit of work table 250).

In some embodiments, upon determining that all of the units of work associated with a particular processing task, such as by accessing the status indicator(s) in unit of work table 220 and/or task table 210, distribution server 130 may load the results to publication database 160. Once loaded to publication database 160, the results may undergo further processing, such as pattern detection, ad hoc analysis and reporting. Some examples of this processing, including pattern recognition and reporting techniques and tools for implementing these techniques, are described in above-referenced U.S. patent application Ser. No. 10/672,767. Of course, the invention is not limited in this regard, as any suitable processing and/or analytic techniques may be employed.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are presented by way of example only.

1. In a grid computing system comprising a server system in networked communication with a plurality of nodes, the server system being operable to divide a processing task into units of work and to assign each of the units of work to one of the plurality of nodes, a method, performed by a node, comprising acts of:
(A) receiving a first unit of work from the server system, the first unit of work requiring an execution of a first sequence of instructions;
(B) determining whether the first sequence of instructions is stored on the node;
(C) if it is determined that the first sequence of instructions is not stored on the node, retrieving the first sequence of instructions from the server system;
(D) executing the first sequence of instructions to perform the unit of work.

2. The method of claim 1, wherein the first unit of work comprises an activity performed to facilitate speech recognition processing.

3. The method of claim 1, wherein the act (A) further comprises receiving a second unit of work from the server system, the second unit of work requiring an execution of a second sequence of instructions; the act (B) further comprises determining whether the second sequence of instructions is stored on the node, the act (C) further comprises, if it is determined that the second sequence of instructions is not stored on the node, retrieving the second sequence of instructions from the server system, and the act (D) further comprises concurrently executing the first and second sequences of instructions such that the first sequence of instructions is executed independently of the second sequence of instructions.

4. The method of claim 3, wherein the act (D) further comprises executing the first and second sequences of instructions in separate application domains.

5. The method of claim 3, wherein the act (D) further comprises concurrently executing the first and second sequence of instructions according to a threaded processing technique.

6. The method of claim 3, wherein the first and second units of work are associated with different processing tasks.

7. The method of claim 3, wherein the first unit of work is associated with recognizing speech in a first language and the second unit of work is associated with recognizing speech in a second language.

8. The method of claim 3, wherein the first unit of work is associated with a first processing task, and the second unit of work is associated with processing a result generated by the first processing task.

9. In a grid computing system comprising a server system in networked communication with a plurality of nodes, the server system being operable to divide a processing task into units of work and to assign each of the units of work to one of the plurality of nodes, a node operable to:
(A) receive a first unit of work from the server system, the first unit of work requiring an execution of a first sequence of instructions;
(B) determine whether the first sequence of instructions is stored on the node;
(C) if it is determined that the first sequence of instructions is not stored on the node, retrieve the first sequence of instructions from the server system; and
(D) execute the first sequence of instructions to perform the unit of work.

10. The node of claim 9, wherein the first unit of work comprises an activity performed to facilitate speech recognition processing.

11. The node of claim 9, wherein receiving a first unit of work further comprises receiving a second unit of work from the server system, the second unit of work requiring an execution of a second sequence of instructions; determining further comprises determining whether the second sequence of instructions is stored on the node, conditionally retrieving further comprises, if it is determined that the second sequence of instructions is not stored on the node, retrieving the second sequence of instructions from the server system, and executing further comprises concurrently executing the first and second sequences of instructions such that the first sequence of instructions is executed independently of the second sequence of instructions.

12. The node of claim 11, wherein executing further comprises executing the first and second sequences of instructions in separate application domains.

13. The node of claim 11, wherein executing the first sequence further comprises concurrently executing the first and second sequence of instructions according to a threaded processing technique.

14. The node of claim 11, wherein the first and second units of work are associated with different processing tasks.

15. The node of claim 11, wherein the first unit of work is associated with recognizing speech in a first language and the second unit of work is associated with recognizing speech in a second language.

16. The node of claim 11, wherein the first unit of work is associated with a first processing task, and the second unit of work is associated with processing a result generated by the first processing task.

17. A computer-readable medium article having stored thereon signals comprising instructions which, when executed by a server system in a grid computing system, wherein the server system is in networked communication with a plurality of nodes, cause the server system to be operable to divide a processing task into units of work and to assign each of the units of work to one of the plurality of nodes, according to a method, performed by a node, comprising acts of:
(A) receiving a first unit of work from the server system, the first unit of work requiring an execution of a first sequence of instructions;
(B) determining whether the first sequence of instructions is stored on the node;
(C) if it is determined that the first sequence of instructions is not stored on the node, retrieving the first sequence of instructions from the server system; and
(D) executing the first sequence of instructions to perform the unit of work.

18. The article of claim 17, wherein the first unit of work comprises an activity performed to facilitate speech recognition processing.

19. The article of claim 17, wherein the act (A) further comprises receiving a second unit of work from the server system, the second unit of work requiring an execution of a second sequence of instructions; the act (B) further comprises determining whether the second sequence of instructions is stored on the node, the act (C) further comprises, if it is determined that the second sequence of instructions is not stored on the node, retrieving the second sequence of instructions from the server system, and the act (D) further comprises concurrently executing the first and second sequences of instructions such that the first sequence of instructions is executed independently of the second sequence of instructions.

20. The article of claim 18, wherein the act (D) further comprises executing the first and second sequences of instructions in separate application domains.

21. The article method of claim 17, wherein the act (D) further comprises concurrently executing the first and second sequence of instructions according to a threaded processing technique.

22. The article of claim 17, wherein the first and second units of work are associated with different processing tasks.

23. The article of claim 17, wherein the first unit of work is associated with recognizing speech in a first language and the second unit of work is associated with recognizing speech in a second language.

24. The article of claim 17, wherein the first unit of work is associated with a first processing task, and the second unit of work is associated with processing a result generated by the first processing task.
